(19) United States
(12) Patent Application Publication
(10) Pub. No.: US 2012/0188183 A1
(43) Pub. Date: Jul. 26, 2012

(54) TERMINAL HAVING TOUCH SCREEN AND METHOD FOR IDENTIFYING TOUCH EVENT THEREIN

(75) Inventors: Hoon Do HEO, Suwon-si (KR); Jong Dae PARK, Suwon-si (KR)

(73) Assignee: SAMSUNG ELECTRONICS CO. LTD., Suwon-si (KR)

(21) Appl. No.: 13/351,522

(22) Filed: Jan. 17, 2012

(30) Foreign Application Priority Data
Jan. 24, 2011 (KR) 10-2011-0006677

(51) Int. Cl. G06F 3/041

(52) U.S. Cl. 345/173

(57) ABSTRACT

A terminal having a touch screen and a method for identifying a touch event thereon are provided. The method includes determining a sensed location of a touch event on a touch screen when the touch event is sensed, calculating a maximum changed value of a touch signal of a center node and a changed value of a touch signal of at least one peripheral node, the peripheral node being located around the center node at the sensed location, and determining whether the touch event is a hovering event of an input tool proximate to the touch screen according to the calculated maximum changed value and the calculated changed value of the touch signal of the at least one peripheral node. The terminal may analyze a touch signal changed according to an input tool in order to identify a type of the touch event. Accordingly, the terminal may identify an unintentional touch event.

### PRIORITY

This application claims the benefit under 35 U.S.C. §119(a) of a Korean patent application filed on Jan. 24, 2011 in the Korean Intellectual Property Office and assigned Serial No. 10-2011-0006677, the entire disclosure of which is hereby incorporated by reference.

### BACKGROUND OF THE INVENTION

1. Field of the Invention

The present invention relates to a terminal having a touch screen and a method for identifying a touch event thereon. More particularly, the present invention relates to a terminal having a touch screen and a method for determining whether a touch event is input through a stylus or a hovering when the touch event is sensed in the terminal.

2. Description of the Related Art

In general, a touch screen includes a display unit and a touch sensor attached to the display unit in order to perform an input function. The touch screen is attached to a small terminal having a small size. In particular, a touch screen is used as an input device for inputting characters or selecting a menu or menu item in the small terminal due to convenience of input on a touch screen and a lack space in the terminal for a separate input unit in the small terminal.

The touch screen senses an input of a user using various types of touch sensors. The touch sensor may be a capacitive overlay type, a pressure resistive overlay type, or an infrared beam type touch sensor. Among the various types of the touch sensors, since a reaction speed of the capacitive overlay type touch sensor is high at a touch time, an error rate is low, a duration of a sensing is long, and light transmittance of the display unit is high so as to maintain an original color of an image displayed on the display unit, the capacitive overlay type is widely used.

However, a high touch sensitivity level should be set in order to support a stylus as an input tool in the capacitive overlay type touch sensor. In other words, a capacitive overlay type touch sensor should be set to be highly sensitive in order to sense the stylus touch input. In this case, although a user's finger is located near to a touch screen, or in other words, the user's finger is hovering above the touch screen, without contacting the touch screen, a problem occurs in that a terminal may recognize the user's finger hovering above the touch screen as a touch event. Furthermore, to address this problem, when a user sets sensitivity differently in the terminal according to a type of an input tool, modes for various applications should be set to be separated.

### SUMMARY OF THE INVENTION

Aspects of the present invention are to address the above-mentioned problems and/or disadvantages and to provide at least the advantages described below. Accordingly, an aspect of the present invention is to provide a terminal and a method for identifying a touch event therein.

In accordance with an aspect of the present invention, a method for identifying a touch event in a terminal having a touch screen is provided. The method includes determining a sensed location of a touch event on a touch screen when the touch event is sensed, calculating a maximum changed value of a touch signal of a center node and a changed value of a touch signal of at least one peripheral node, the at least one peripheral node being located around the center node at the sensed location, and determining whether the touch evening is a hovering event of an input tool proximate to the touch screen according to the calculated maximum changed value and the calculated changed value of the touch signal of the at least one peripheral node.

In accordance with an aspect of the present invention, a terminal for identifying a touch event is provided. The terminal includes a touch screen for sensing coordinates of a sensed location of the touch event through a touch sensor composed of a plurality of nodes, and a controller for calculating a maximum changed value of a touch signal of a center node, for calculating a changed value of a touch signal of at least one peripheral node located around the center node at the sensed location, and for determining whether the touch event is a hovering event of an input tool proximate to the touch screen according to the calculated maximum changed value and the calculated changed value of the touch signal of the at least one peripheral node.

In accordance with another aspect of the present invention, a terminal for identifying a touch event is provided. The terminal includes a touch screen having a touch sensor composed of a plurality of nodes for receiving a touch event, the terminal comprising a controller for controlling the terminal, the controller comprising a touch location determining unit for determining coordinates of a location of the touch event and a hovering determining unit for determining whether the touch event is a hovering event when an input tool is proximate to the touch screen, and a memory for storing touch identifying information including a preset hovering threshold value.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of the present invention will be more apparent from the following description taken in conjunction with the accompanying drawings, in which:

FIG. 1 is a block diagram illustrating a configuration of a terminal according to an exemplary embodiment of the present invention;

FIG. 2 illustrates a signal changed according to a sensed touch event according to an exemplary embodiment of the present invention;

FIG. 3 illustrates a method for identifying a touch event based on a sensed signal according to an exemplary embodiment of the present invention;

FIG. 4 illustrates a method for identifying a touch event when a touch event occurs at a first region of a touch screen according to an exemplary embodiment of the present invention;

FIG. 5 illustrates a method for identifying a touch event when a touch event occurs at a second region of a touch screen according to an exemplary embodiment of the present invention;

FIG. 6 illustrates a method for identifying a touch event when a touch event occurs at a third region of a touch screen according to an exemplary embodiment of the present invention;

FIG. 7 is a flowchart illustrating a method for sensing a touch event according to an exemplary embodiment of the present invention; and

FIG. 8 is a flowchart illustrating a method for identifying a touch event sensed based on each region of a touch screen according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description, with reference to the accompanying drawings, is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Particular terms may be defined herein to help describe the exemplary embodiments of the invention in the best manner. Accordingly, the meaning of specific terms or words used in the specification and the claims should not be limited to the literal or commonly employed sense, but should be construed in accordance with the spirit of the invention.

As used herein, the term “input event” means an event wherein a user contacts an input tool, such as a finger or a stylus, with a touch screen. As used herein, the term “hovering event” means an event wherein a user makes an input tool such as a finger or a stylus be proximate to, or hover above, a touch screen without allowing it to contact the touch screen. As used herein, the term “center node” means a touch sensor sensing the most frequently changed touch signal value from among a plurality of nodes sensing a touch signal changed according to a touch event as a base element constituting a touch sensor of a touch screen.

As used herein, the term “peripheral node” means at least one touch sensor located around the center node. As used herein, the term “maximum changed value of a touch signal” means a changed value of a touch signal sensed in the center node. As used herein, the term “changed value of a peripheral touch signal” means a changed value of a touch signal sensed by at least one peripheral node. As used herein, the term “terminal” means a terminal providing convenience to a user. The terminal may include one or more of various electronic, information and communication devices and multimedia devices such as a mobile communication terminal allowing a user to use a digital broadcasting service, a Digital Multimedia Broadcast (DMB) receiver, a Personal Digital Assistant (PDA), and a Smart Phone. However, the present invention is not limited thereto, and other suitable electronic devices may be a terminal.

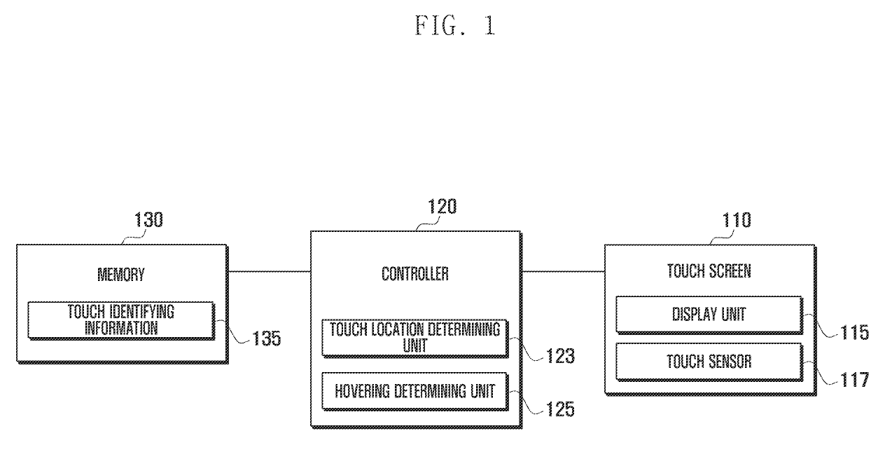

FIG. 1 is a block diagram illustrating a configuration of a terminal according to an exemplary embodiment of the present invention.

Referring to FIG. 1, a terminal includes a touch screen 110, a controller 120, and a memory 130.

The touch screen 110 includes a display unit 115 and a touch sensor 117 provided at one side of the display unit 115. The display unit 115 displays information input by a user, information provided to the user as well as various types of menus. Here, the display unit 115 may be a Liquid Crystal Display (LCD), a Light Emitting Diode (LED) display, an Organic LED (OLED) display, or other suitable types of displays.

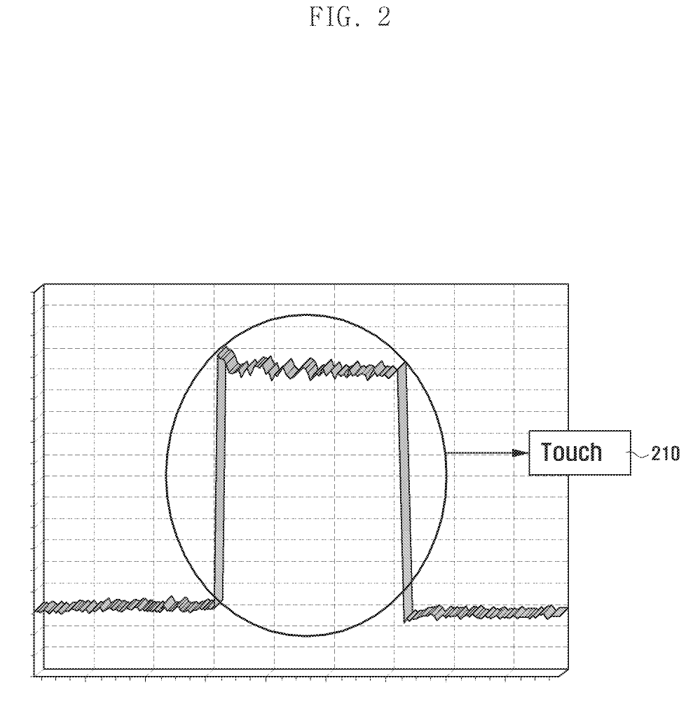

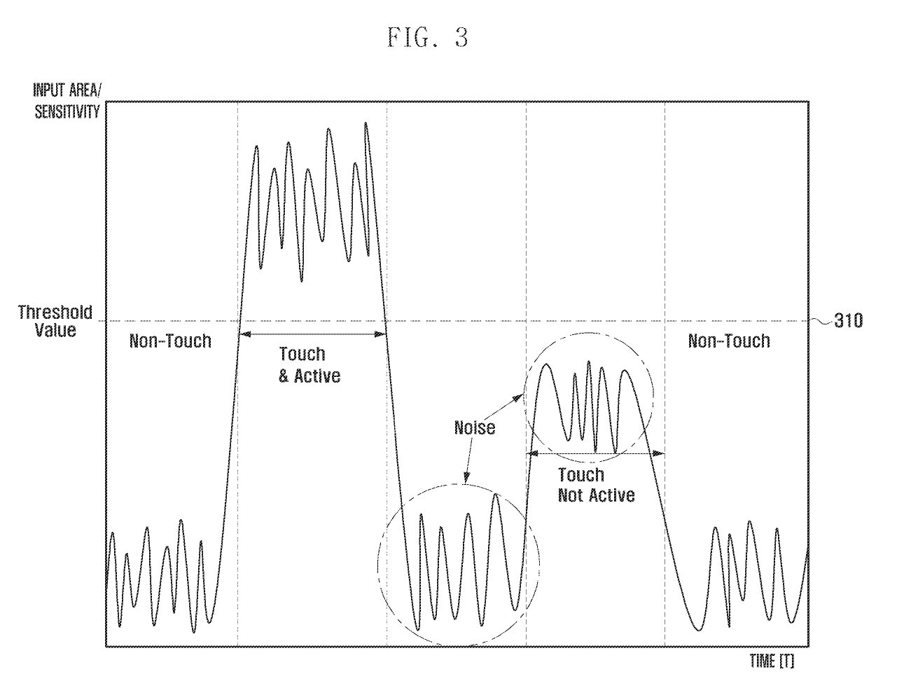

The touch sensor 117 may be disposed at one side of the display unit 115 in order to sense a touch event occurring on a surface of the display unit 115. Furthermore, the touch sensor 117 may detect coordinates of the touch event, or, in other words, a location value of an occurrence region of the touch event. A capacitive overlay type sensor, ultrasonic reflection type sensor, or an optical sensor and electromagnetic induction type sensor is used as the touch sensor 117. However, the present invention is not limited thereto, and other suitable types of sensors may be used. Presently, it is assumed that the touch sensor 117 is the capacitive overlay type. The capacitive overlay type touch sensor 117 includes a plurality of nodes so that a signal that is changed according to an occurrence of a touch event is sensed through a node of the touch sensor 117. The plurality of nodes also sense an occurrence of the touch event and may be used to determine coordinates of a location of the touch event. A method of sensing a touch event according a changed touch signal will be described with reference to FIG. 2 and FIG. 3 below.

The controller 120 may control an overall operation of the terminal and signal flow between internal elements of the terminal, and perform a data processing function. Here, the controller 120 may determine an amount of a change in a touch signal according to a sensed location of a touch event on the touch screen 110 in order to determine a type of the touch event. Here, the type of the touch event may be an input event in which an input tool contacts the display unit 115 or a hovering event in which an input tool such as a user finger is located proximate to the display unit 115. However, the present invention is not limited thereto, and other similar types of touch events may be touch events on the display unit 115.

In order to determine the type of the touch event, the controller 120 includes a touch location determining unit 123 and a hovering determining unit 125.

The touch location determining unit 123 determines a region of the touch screen 110 where the touch event is sensed. In detail, if coordinates corresponding to the location of the sensed touch event, as sensed by the touch sensor 117, are transmitted, the touch location determining unit 123 determines the region of the touch screen 111 where the touch event is sensed. In the present exemplary embodiment, the touch screen 110 may be divided into three regions. For example, when the touch screen 110 is a square shape, edge regions located between four corners of the touch screen 110 may become a first region. Meanwhile, a side region located at corners of the touch screen 110 may become a second region. Finally, a body region being a remaining region not including the corners and edges of the touch screen 110 may become a third region.

The touch location determining unit 123 may determine at the region at which the touch event is sensed through coordinates corresponding to each region. The coordinates corresponding to each region may be predetermined before the occurrence of the touch event. That is, the touch location determining unit 123 determines whether coordinates of the sensed location of the touch event are included in coordinates corresponding to an edge region of the touch screen 110. If the sensed location coordinates are included in the coordinates corresponding to the edge region, the controller 120 may determine that the touch event occurred in the edge region of the touch screen 110. In this manner, the touch location determining unit 123 may determine a region of the touch screen 10 where the touch event is sensed.

The hovering determining unit 125 may detect a change in a signal strength of touch screen nodes on which a touch event is sensed, wherein the touch screen nodes are disposed in a region of the touch screen 110 determined by the touch location determining unit 123. The detected change in signal strength is used to determine a type of the touch event. In detail, the hovering determining unit 125 may detect a changed amount of a touch signal of a center node, which is a node having the highest amount of change of the touch signal and may also detect a changed amount of a touch signal of a peripheral node, which is a node located around the center node. The detected changed amounts of the touch signals are used to determine a type of the occurred touch event.

The hovering determining unit 125 determines a maximum delta value that is a maximum change of a touch signal value sensed on the center node. Furthermore, the hovering determining unit 125 determines individual delta values that are a changed amount of a touch signal sensed on at least one peripheral node that are located around the center node and that are disposed in a region of the touch screen 110 including a sensed location of the touch event. Next, the hovering determining unit 125 calculates an average delta value that is an average value of the individual delta values. Here, the hovering determining unit 125 sums all of the individual delta values and divides the sum by a number of peripheral nodes corresponding to the summed individual delta values in order to calculate the average delta value.

The hovering determining unit 125 compares the maximum delta value with the average delta value. At this time, the hovering determining unit 125 divides the average delta value by the maximum delta and multiplies the division result by 100 in order to calculate a difference value. Further, the hovering determining unit 125 compares the calculated difference value with a preset hovering threshold value. The hovering determining unit 125 determines a type of touch event by determining whether the sensed touch event is an input event or a hovering event based on the result of the comparison between the calculated difference value and the preset hovering threshold.

The controller 120 may perform a function set according to the type of the touch event determined through the touch location determining unit 123 and the hovering determining unit 125. For example, when the touch event is determined to be the input event, the controller 120 may perform a function correlated to the sensed location of the touch event. Meanwhile, when the determined touch event is the hovering event, the controller 120 waits for the touch event until the input event is sensed.

The memory 130 stores both programs necessary for the function operation of the terminal but also data created during a function operation of the terminal. The memory 130 stores touch identifying information 135 for identifying a touch event. The touch identifying information 135 may contain an input threshold value for identifying an input event in which an input tool contacts the touch screen 110 and a hovering input value for identifying a hovering event in which the input tool approaches the touch screen 110. In the present exemplary embodiment, it is assumed that the hovering threshold value is 30%. However, the present invention is not limited thereto, and the hovering threshold value may change according to an environment of the terminal, a manufacturing company, and selection of a user.

Although not shown in drawings, the terminal may further include various elements corresponding to other performance functions. For example, the terminal may further include a communication unit for transmitting and receiving data such as speeches, images, or characters, a camera unit for photographing images, a digital broadcasting receiver for receiving digital broadcasting data, and a near distance communication unit for performing near distance communication, or other similar elements for similar functions performed by a terminal.

The terminal having a structure as described above determines delta values by nodes according to a region of the touch screen 110 including a sensed location of the touch event. Furthermore, the terminal may determine whether the touch event is an input event or a hovering event according to the delta values.

FIG. 2 illustrates a signal changed according to a sensed touch event according to an exemplary embodiment of the present invention.

Referring to FIG. 2, if a touch event 210 is sensed on a touch screen 110, a signal is changed. In this case, a changed signal value, which changes with respect to a reference value, is called a delta value.

FIG. 3 illustrates a method for identifying a touch event based on a sensed signal according to an exemplary embodiment of the present invention.

FIG. 3 shows a delta value that is changed when a touch event is sensed on the touch screen 110. To identify an input event, the hovering determining unit 125 may determine whether a touch event is the input event or a hovering event according to a threshold value 310. Further, the threshold value 310 may be set differently according to whether a stylus or a user finger is used as the input tool. Furthermore, the threshold value 310 that is set when an input tool such as a stylus is used may be higher than the threshold value 310 that is set when a user's finger is used as the input tool. Accordingly, if a delta value that is changed according to noise input is less than the threshold value 310 that is set when an input tool such as the stylus is used and the delta value is greater than the threshold value that is set when the user's finger is used as the input tool, the controller 120 cannot determine whether the sensed touch event is the input event or the hovering event. In order to prevent such a problem, the controller 120 may determine a delta value according to a region of the touch screen including the sensed location of the touch event to determine a type of the touch event. For example, the controller may determine a delta value according to a touch and active region or a touch not active region.

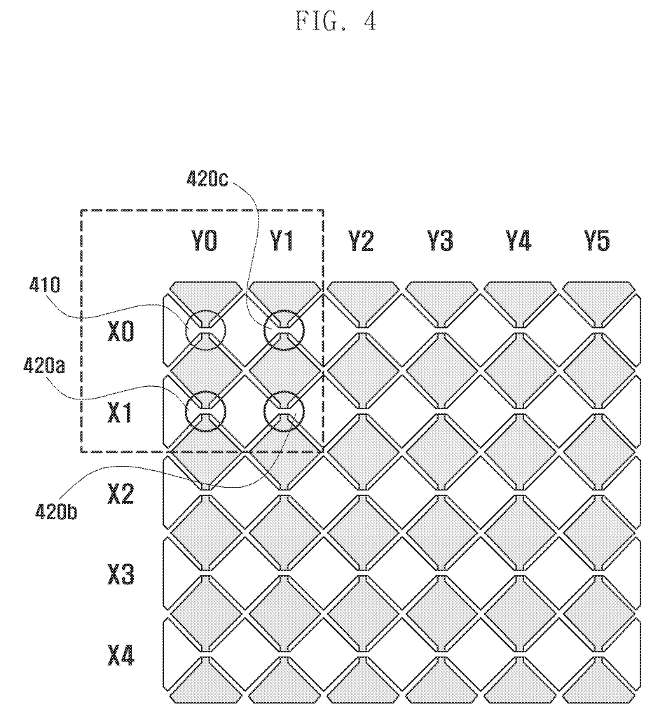

FIG. 4 illustrates a method for identifying a touch event when a touch event occurs at a first region of a touch screen according to an exemplary embodiment of the present invention.

Referring to FIG. 4, when a touch event is sensed at an edge region of a touch screen 110, a controller 120 may determine delta values of nodes included in the edge region from among entire nodes constituting a touch sensor 117 in order to determine a type of the touch event. As shown in FIG. 4, the touch sensor 117 includes rows X0 to X4 and column Y0 to Y5 of touch sensors. However, the present invention is not limited thereto, and the touch sensor 117 may be formed in any manner suitable to sense a touch. In detail, the controller 120 may compare a delta value of a center node to a maximum value and to a delta value of at least one peripheral node located around the center node in order to determine the type of the touch event. In other words, the controller 120 may compare the delta value of the center node to different values, such as the maximum value and the delta value of the at least one peripheral value. In the present exemplary embodiment, it is preferred to determine delta values of at least three peripheral nodes. However, the present invention is not limited thereto, and the delta values of more or less than three nodes may be used.

For example, the controller 120 determines a maximum delta value of the center 410 and respective delta values of three peripheral nodes 420a, 420b, and 420c that are disposed around the center node 410. Next, the controller 120 calculates an average delta value being an average value of the respective delta values of the three peripheral nodes 420a, 420b, and 420c.

Subsequently, the controller 120 calculates a difference value between the maximum delta value and the average delta value. Furthermore, the controller 120 determines whether the calculated difference value is equal to or greater than a preset hovering threshold value. If the calculated difference value is equal to or greater than the preset hovering threshold value, the controller 120 determines that the touch event is a hovering event. Conversely, if the difference value between the maximum delta value and the average delta value is less than the preset hovering threshold value, then the controller 120 determines that the touch event is an input event.

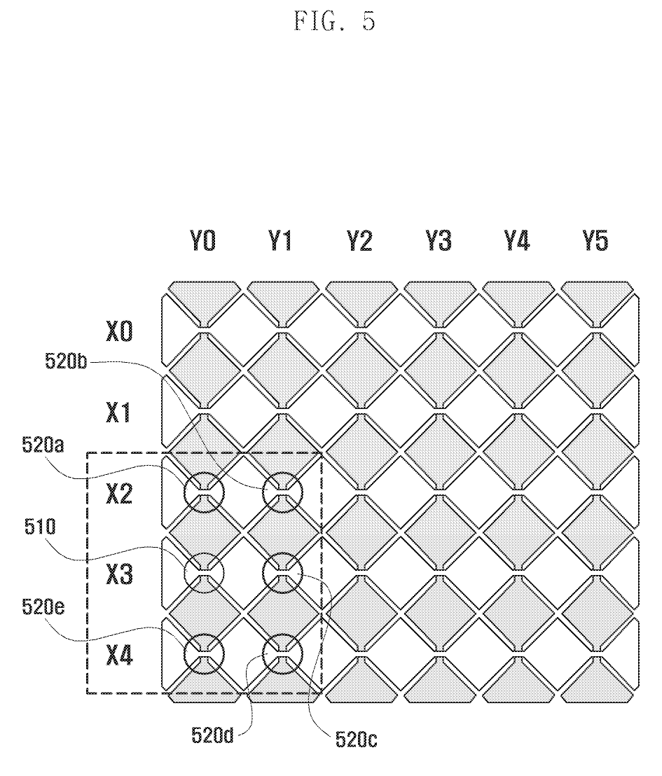

FIG. 5 illustrates a method for identifying a touch event when a touch event occurs at a second region of a touch screen according to an exemplary embodiment of the present invention.

Referring to FIG. 5, when the touch event is sensed at a side region of a touch screen 110, a controller 120 may determine delta values of nodes included in the side region of the touch screen 110 in order to determine a type of the touch event. In detail, the controller 120 may determine a delta value of a center node and a delta value of at least one peripheral node located around the center node to determine a type of the touch event. At this time, it is preferred to determine delta values of at least five peripheral nodes. However, the present invention is not limited thereto, and the delta values of more or less than five nodes may be determined.

For example, the controller 120 determines a maximum delta value of a center node 510 and respective delta values sensed at five nodes 520a, 520b, 520c, 520d, and 520e, which are located around the center node 510. Subsequently, the controller 120 calculates an average delta value being an average value of the respective delta values sensed at the five nodes 520a, 520b, 520c, 520d, and 520e.

Next, the controller 120 calculates a difference value that is a difference between the maximum delta value and the average delta value. Furthermore, the controller 120 determines whether the calculated difference value is equal to or greater than a preset hovering threshold value. If the calculated difference value is equal to or greater than the preset hovering threshold value, then the controller 120 determines that the touch event is a hovering event. Conversely, if the difference value between the maximum delta value and the average delta value is less than the preset hovering threshold value, then the controller 120 determines that the touch event as an input event.

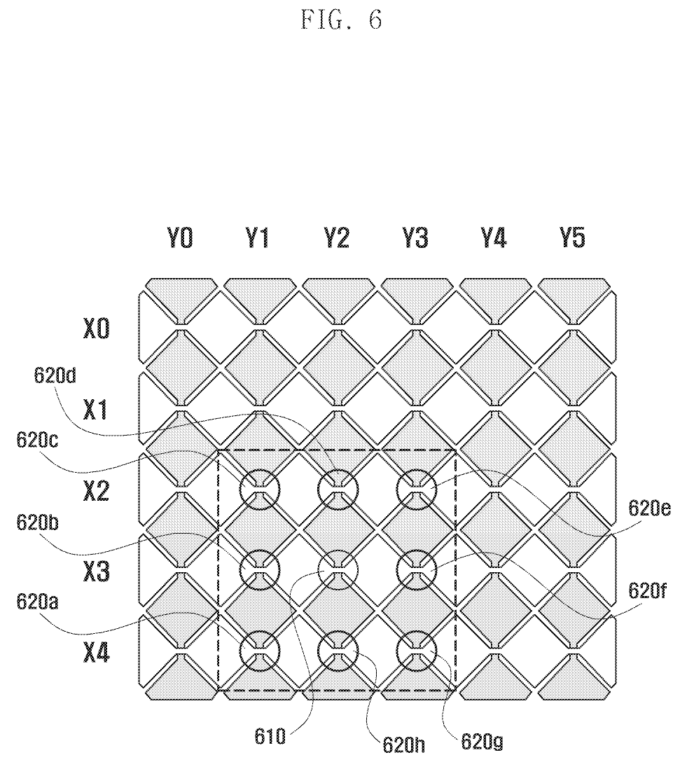

FIG. 6 illustrates a method for identifying a touch event when a touch event occurs at a third region of a touch screen according to an exemplary embodiment of the present invention.

Referring to FIG. 6, when a touch event is sensed a body region that is a remaining region not including the edge region and the side region of the touch screen, the controller 120 may determine delta values of nodes included in the body region in order to determine a type of the touch event. In detail, the controller 120 may determine a delta value of a center node having a maximum delta value and a delta value of at least one peripheral node located around the center node in order to determine a type of the touch event from among a hovering event and an input event. In the present exemplary embodiment, it is preferred to determine delta values of at least eight peripheral nodes. However, the present invention is not limited thereto, and delta values of more or less than eight peripheral nodes may be determined.

For example, the controller 120 determines a maximum delta value of the center node 610 and respective delta values sensed at eight peripheral nodes 620a, 620b, 620c, 620d, 620e, 620f, 620g, and 620h located around the center node 610. Next, the controller 120 calculates an average delta value being an average value of delta values sensed at eight peripheral nodes 620a, 620b, 620c, 620d, 620e, 620f, 620g, and 620h.

Subsequently, the controller 120 calculates a difference value between the maximum delta value and the average delta value. Furthermore, the controller 120 determines whether the calculated difference value is equal to or greater than a preset hovering threshold value. If the calculated difference value is equal to or greater than the preset hovering threshold value, then the controller 120 determines that the touch event is a hovering event. Conversely, if the difference value between the maximum delta value and the average delta value is less than the preset hovering threshold value, then the controller 120 determines that the touch event is an input event.

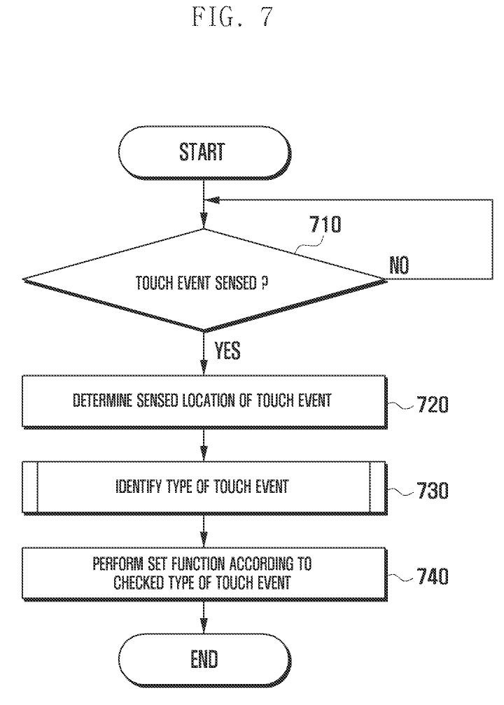

FIG. 7 is a flowchart illustrating a method for sensing a touch event according to an exemplary embodiment of the present invention.

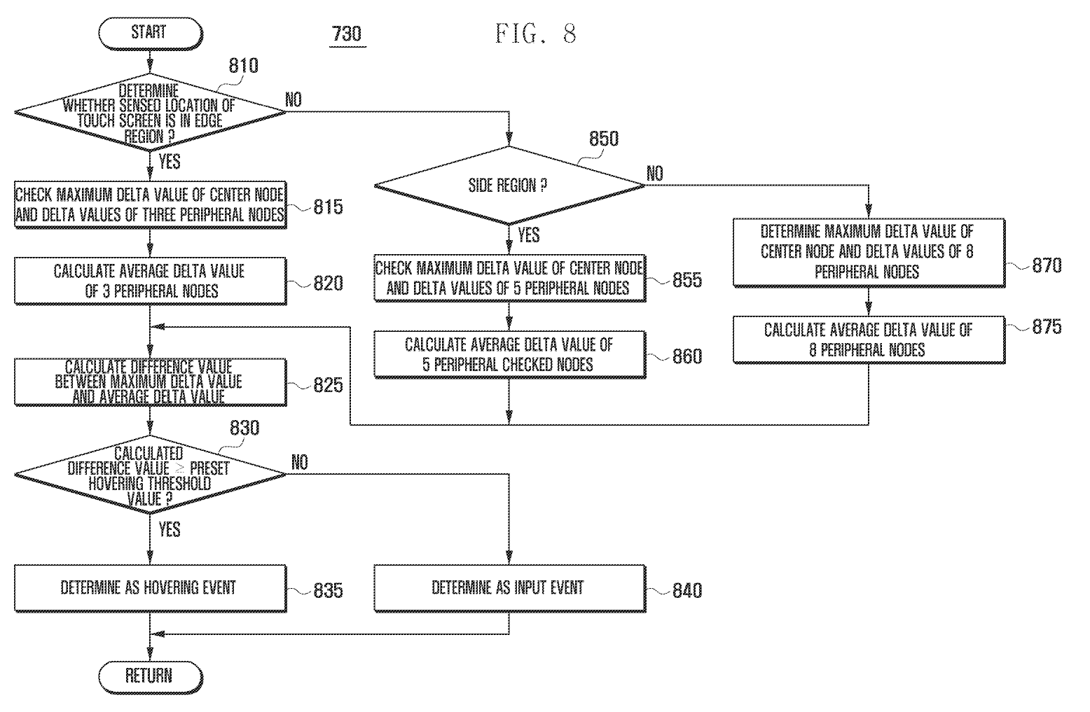

Referring to FIG. 7, a controller 120 determines whether a touch event is sensed through a touch screen 110 in step 710. If the touch event is sensed through the touch screen 110, then, in step 720, the controller 120 determines a sensed location of a touch event on the touch screen 110 through coordinates provided from a touch sensor 117. Next, the controller 120 calculates a changed value of the sensed touch signal corresponding to the determined location in order to identify a type of the touch event in step 730. In this case, step 730 will be described with reference to FIG. 8 below.

Subsequently, in step 740, the controller 120 performs a set function that is set according to the determined type of the touch event. Here, the set function may be one of various functions to be performed by the terminal. Furthermore, there may be an input event occurring when an input tool directly contacts a touch screen 110 and a hovering event occurring when the input tool is located close to the touch screen 110.

If the identified touch event is the input event, the terminal identifies a function mapped to a sensed location of the touch event. Furthermore, if the touch event is released, the terminal performs the identified function. In the meantime, if the identified touch event is a hovering event, the terminal waits for the touch event until the input event is sensed.

Subsequently, the calculating of the changed value of a touch signal sensed at the determined location, which is done in order to identify the type of the touch event in step 730, will be described with reference to FIG. 8.

FIG. 8 is a flowchart illustrating a method for identifying a touch event sensed based on each region of a touch screen according to an exemplary embodiment of the present invention.

Referring to FIG. 8, if a touch event is sensed, a controller 120 determines a sensed location of the touch event on a touch screen 110. The controller 120 determines whether the sensed location is an edge region of the touch screen 110 in step 810. The following is a method for determining whether the sensed location of the touch event is the edge region. The controller 120 determines coordinates of the sensed location of the touch event. Furthermore, the controller 120 determines whether the determined coordinates are included in coordinates corresponding to the edge region of the touch screen 110. If the determined coordinates correspond to the coordinates of the edge region of the touch screen 110, then the controller 120 may determine that the touch event is sensed at the edge region of the touch screen 110.

If the sensed location is in the edge region, then, in step 815, the controller 120 determines a maximum changed value, which is referred to as a maximum delta value hereinafter, of a touch signal of a center node and respective changed values, which are referred to as delta values hereinafter, of the touch signal sensed at three peripheral nodes located around the center node. Subsequently, the controller 120 calculates an average value, which is referred to as an average delta value hereinafter, of changed values of the touch signal sensed at the three peripheral nodes in step 820. In detail, the controller 120 sums three changes values of the touch signal and then divides the sum of the changed values by 3 in order to calculate the average delta value.

Next, the controller 120 calculates a difference value between the maximum delta value and the average delta value in step 825. In detail, the controller 120 divides the average delta value by the maximum delta value and multiplies the division result by 100 in order to calculate a percent change of the delta value. Subsequently, the controller 120 determines whether the calculated difference value is equal to or greater than a preset hovering threshold value in step 830. In the present exemplary embodiment the hovering threshold value is 30%. However, the present invention is not limited thereto, and the hovering threshold value may be any suitable value. If the calculated difference value is equal to or greater than the preset hovering threshold value, the controller 120 determines the touch event as a hovering event in step 835. In other words, the controller 120 compares the maximum delta value with the average delta value. If the difference value between the maximum delta value and the average delta value is 30%, which is set to be the hovering threshold value, the controller 120 recognizes the touch event as the hovering event. Conversely, if the difference value between the maximum delta value and the average delta value is less than the preset hovering threshold value, then the controller 120 determines the touch event to be an input event in step 840.

Conversely, if the sensed location of the touch event is not determined to be in the edge region of the touch screen 110 at step 810, then the controller 120 determines whether the sensed location of the touch event is in a side region of the touch screen 110 in step 850. The following is a method of determining whether the sensed location of the touch event is in the side region of the touch screen 110. The controller 120 determines coordinates of the sensed location of the touch event and the controller 120 determines whether the determined coordinates are included in coordinates corresponding to the side region of the touch screen 110. If the determined coordinates are included in the coordinates corresponding to the side region, the controller 120 determines that the touch event is sensed at the side region of the touch screen 110.

If the sensed location of the touch event is the side region, the controller 120 determines a maximum delta value of a center node and delta values sensed at five peripheral nodes located around the center node in step 855. Further, the controller 120 calculates an average delta value of the five peripheral nodes in step 860. In other words, the controller 120 sums all of the delta values sensed on the five peripheral nodes and divides the sum by 5 in order to obtain the average delta value.

Next, the controller 120 calculates a difference value between the maximum delta value and the average delta value in step 825. In detail, the controller 120 divides the average delta value by the maximum delta value and multiplies the division result value by 100. Next, the controller 120 determines whether the calculated difference value is equal to or greater than a preset hovering threshold value in step 830. In the present exemplary embodiment, the hovering threshold value is 30%. However, the present invention is not limited thereto, and the hovering threshold may be any suitable value. If the calculated difference value is equal to or greater than the preset hovering threshold value, then the controller 120 determines the touch event as a hovering event in step 835. Conversely, if the difference value between the maximum delta value and the average delta value is less than a preset hovering threshold value, then the controller 120 determines the touch event as an input event in step 840.

If the sensed location of the touch event is not determined to be in the side region at step 850, then the controller 120 determines a maximum delta value of a center node and delta values of eight peripheral nodes in step 870. Subsequently, the controller 120 calculates an average delta value of the delta values of the eight peripheral nodes in step 875. In other words, the controller 120 sums the delta values of eight peripheral nodes and divides the sum of the delta values by 8 being the number of the peripheral nodes to obtain an average delta value.

Next, the controller 120 proceeds on to step 825, as discussed above, in order to calculate a difference value between the maximum value and the average delta value. Subsequent to step 825, the controller 120 proceeds in a manner as discussed above in order to determine whether the touch event is a hovering event in step 835 or an input event in step 840.

Through the foregoing procedures, the terminal may identify whether a type of the touch event is an input event using a stylus or a hovering event according to a proximity of a user's finger.

According to exemplary embodiments of the present invention, a user may use the terminal without changing an input tool with respect to applications. The terminal may analyze a signal changed according to an input tool in order to identify a type of the touch event. Accordingly, the terminal may identify an unintentional touch event.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method for identifying a touch event in a terminal having a touch screen, the method comprising:
determining a sensed location of a touch event on a touch screen when the touch event is sensed;
calculating a maximum changed value of a touch signal of a center node and a changed value of a touch signal of at least one peripheral node, the at least one peripheral node being located around the center node at the sensed location; and
determining whether the touch event is a hovering event of an input tool proximate to the touch screen according to the calculated maximum changed value and the calculated changed value of the touch signal of the at least one peripheral node.

2. The method of claim 1, wherein the calculating of the maximum changed value comprises:
determining whether the sensed location is included in a first region, a second region, or a third region of the touch screen; and
determining the maximum changed value of the touch signal of the center node and the changed value of the touch signal of the at least one peripheral node located around the center node according to at least one of the first region, the second region, and the third region.

3. The method of claim 2, wherein the determining of the maximum changed value further comprises:
determining the maximum changed value of the touch signal of the center node and at least three changed values of touch signals of at least three peripheral nodes located around the center node when the sensed location is determined to be included in the first region; and
calculating an average of the at least three changed values of touch signals of the at least three peripheral nodes.

4. The method of claim 2, wherein the determining of the maximum changed value further comprises:
determining the maximum changed value of the touch signal of the center node and at least five changed values of touch signals of at least five peripheral nodes located around the center node when the sensed location is determined to be included in the second region; and
calculating an average of the at least five changed values of touch signals of the at least five peripheral nodes.

5. The method of claim 2, wherein the determining of the maximum changed value further comprises:
determining the maximum changed value of the touch signal of the center node and at least eight changed values of touch signals of at least eight peripheral nodes located around the center node when the sensed location is determined to be included in the third region; and
calculating an average of the at least eight changed values of touch signals of the at least eight peripheral nodes.

6. The method of claim 1, wherein the determining of the hovering event comprises:
calculating a difference value between the maximum changed value of the touch signal and the changed value of the touch signal;
determining whether the difference value is equal to or greater than a preset hovering threshold value; and
determining the touch event to be the hovering event when the calculated difference value is equal to or greater than the preset hovering threshold value.

7. The method of claim 6, further comprising determining the touch event as an input event contacting the touch screen when the calculated difference value is less than the hovering threshold value.

8. A terminal for identifying a touch event, the terminal comprising:
a touch screen for sensing coordinates of a sensed location of the touch event through a touch sensor composed of a plurality of nodes; and
a controller for calculating a maximum changed value of a touch signal of a center node, for calculating a changed value of a touch signal of at least one peripheral node located around the center node at the sensed location, and for determining whether the touch event is a hovering event of an input tool proximate to the touch screen according to the calculated maximum changed value and the calculated changed value of the touch signal of the at least one peripheral node.

9. The terminal of claim 8, wherein the controller determines whether the sensed location is included in a first region, a second region, or a third region of the touch screen; and
wherein the controller determines the maximum changed value of the touch signal of the center node and the changed value of the touch signal of the at least one peripheral node located around the center node according to the at least one of the first region, the second region, and the third region.

10. The terminal of claim 9, wherein the controller determines the maximum changed value of the touch signal of the center node and at least three changed values of touch signals of at least three peripheral nodes located around the center node when the sensed location is determined to be included in the first region; and
wherein the controller calculates an average of the at least three changed values of touch signals of the at least three peripheral nodes.

11. The terminal of claim 9, wherein the controller determines a maximum changed value of the touch signal of the center node and at least five changed values of touch signals of at least five peripheral nodes located around the center node when the sensed location is determined to be included in the second region; and
wherein the controller calculates an average of the at least five changed values of touch signals of the at least five peripheral nodes.

12. The terminal of claim 9, wherein the controller determines a maximum changed value of a touch signal of the center node and at least eight changed values of touch signals of at least eight peripheral nodes located around the center node when the region is the third region; and
wherein the controller calculates an average of the at least eight changed values of touch signals of the at least eight peripheral nodes.

13. The terminal of claim 8, wherein the controller calculates a difference value between the maximum changed value of the touch signal and the changed value of the touch signal;
wherein the controller determines whether the difference value is equal to or greater than a preset hovering threshold value; and
wherein the controller determines the touch event to be the hovering event when the calculated difference value is equal to or greater than the preset hovering threshold value.

14. The terminal of claim 13, wherein the controller determines the touch event to be an input event contacting the touch screen when the calculated difference value is less than the hovering threshold value.

15. A terminal including a touch screen having a touch sensor composed of a plurality of nodes for receiving a touch event, the terminal comprising:
a controller for controlling the terminal, the controller comprising:
a touch location determining unit for determining coordinates of a location of the touch event; and
a hovering determining unit for determining whether the touch event is a hovering event when an input tool is proximate to the touch screen; and
a memory for storing touch identifying information including a preset hovering threshold value.

16. The terminal of claim 15, wherein the hovering determining unit calculates a maximum changed value of a touch signal of a center node and calculates a changed value of a touch signal of at least one peripheral node disposed around the center node at the sensed location, and
wherein the hovering determining unit determines that a hovering event occurs when an input tool is proximate to the touch screen according to the calculated maximum changed value of a touch signal and the at least one calculated changed value of the touch signal of the at least one peripheral node.

17. The terminal of claim 15, wherein the touch identifying information comprises an input threshold value for identifying an input event in which the input tool contacts the touch screen.

18. The terminal of claim 15, wherein the touch location determining unit determines if the touch event occurs in a first region, a second region, or a third region of the touch panel.

19. The terminal of claim 15, wherein the hovering determining unit determines a difference value between the maximum changed value of the touch signal and the changed value of the touch signal,
and wherein the hovering determining unit determines that the hovering event occurs when the difference value is equal to or greater than the preset hovering threshold value.

20. The terminal of claim 15, wherein the preset hovering threshold value is a predetermined ratio between a maximum touch signal value and an average touch signal value.
